(19) United States
(12) Patent Application Publication
(10) Pub. No.: US 2026/0064403 A1
(43) Pub. Date: Mar. 5, 2026

(54) PROTOCOL-AWARE HITLESS FIRMWARE UPDATE FOR PROGRAMMABLE LOGIC CONTROLLERS

(71) Applicant: Aivres Systems Inc., Fremont, CA (US)

(72) Inventor: Yuan-Chih LO, New Taipei City (TW)

(21) Appl. No.: 19/385,429

(22) Filed: Nov. 11, 2025

(51) Int. Cl. G06F 8/656; G05B 19/05

(52) U.S. Cl. CPC G06F 8/656; G05B 19/056

(57) ABSTRACT

A programmable logic controller in a powered system performs a hitless firmware update coordinated with a management controller. The management controller stages updated firmware and asserts a freeze signal. In response, and before any I/O-state freeze, the programmable logic controller proactively drives each communication interface that it is actively mastering (e.g., I²C, SPI, SGPIO) to a protocol-defined idle state by completing any in-progress transaction, issuing an end-of-transfer condition, and pausing further transactions. The controller then freezes its I/O pin states for a bounded interval, receives a reload command, and switches execution to the staged firmware. After the reload, the controller unfreezes its I/O and resumes normal operation. This protocol-aware quiesce prevents mid-transaction bus lock and enables reliable remote firmware updates without removing system power.

### TECHNICAL FIELD

This disclosure relates to programmable logic controllers used in information handling systems, such as complex programmable logic devices (CPLDs) on server and storage platforms. It concerns methods and apparatus for remotely updating controller firmware while the system remains powered, with protocol-aware quiescing of communication interfaces to prevent transaction-level faults (including transient errors) during reload.

### BACKGROUND

Server and storage platforms commonly use a programmable logic controller to host management buses and control functions such as sensor polling, power-enable signaling, and status indicators. The controller’s firmware is periodically updated in the field by a management controller while the system remains powered. Existing “hitless” approaches attempt to preserve continuity by freezing Input/Output (I/O) states during a reload of updated firmware, but they operate at the electrical level only.

When the controller is acting as the host of a communication interface at the time of reload, an I/O freeze can bisect an active transaction and leave the interface in a non-idle state. If a protocol-defined end-of-transfer is not observed by the remote device, lines may remain asserted, frames may be truncated, and streams may be left mid-cycle. These conditions cause transmission errors, stuck-bus states, and misleading telemetry, leading to alarms and false faults, watchdog events, delayed thermal or power protection actions, and loss of management visibility until recovery completes.

Recovery is costly and not always automatic. Typical procedures (e.g., clocking or resets to clear a bus, timeout-driven reinitialization of protocol engines, or even resetting attached devices) consume time, may require operator intervention, and risk service disruption in high-availability environments. Accordingly, there is a need for an update mechanism that maintains system power yet prevents mid-transaction protocol faults, avoids stuck-bus conditions, and eliminates the post-reload recovery burden.

### SUMMARY

A system of one or more computers can be configured to perform particular operations by virtue of software, firmware, hardware, or any combination thereof that, in operation, causes the system to perform those operations. Likewise, one or more computer programs can be configured to perform particular operations by including instructions that, when executed by data-processing apparatus, cause the apparatus to perform to operations.

In one general aspect, a method includes receiving, at a programmable logic controller, a freeze signal from a management controller requesting an I/O-state freeze for an impending firmware reload of updated firmware stored in a memory accessible to the programmable logic controller. In response to the freeze signal and prior to the I/O-state freeze, the method further includes driving each communication interface that the programmable logic controller is actively mastering to an idle state by completing any in-progress transaction and pausing initiation of subsequent transactions on the interface. Upon determining that either each communication interface has reached the idle state or a guard-interval delay expires, the method then freezes the I/O pin states of the programmable logic controller for a bounded interval. During that bounded interval, the method receives, from the management controller, a reload command and, in response, switches execution from prior firmware to the updated firmware. The method concludes by unfreezing the I/O pin states and continuing operation under the updated firmware. Other embodiments of this aspect include corresponding computer systems, apparatus, and computer programs recorded on one or more computer-storage devices, each configured to perform the actions of the method.

Implementations may include one or more of the following features. Continuing operation may include resuming, from the idle state, initiation of transactions on each communication interface whose initiation was paused. Completing the in-progress transaction may include refraining from freezing one or more I/O pin states associated with each communication interface until the programmable logic controller has generated a protocol-specified end-of-transfer condition on the interface. Proactive driving to the idle state may be performed concurrently across multiple communication interfaces. Prior to freezing the I/O pin states, a configurable guard-interval delay sufficient for proactive driving to complete may be introduced. The guard-interval delay may be set by the management controller via a writable register of the programmable logic controller and may be determined based at least on bus clock rate, a minimum number of clock cycles to complete an end-of-transfer, and a configurable safety margin. The bounded interval during which the I/O pin states are frozen may be configurable.

The management controller may include a baseboard management controller (BMC). The memory may include a configuration flash memory storing a firmware image for the programmable logic controller. The communication interface may include an Inter-Integrated Circuit (I²C) bus, where driving to the idle state includes completing a current data byte and generating a STOP condition, and pausing further transactions by inhibiting assertion of a subsequent START condition. The communication interface may include a Serial Peripheral Interface (SPI), where driving to idle includes completing a current frame boundary and de-asserting a chip-select signal, and pausing further transactions by inhibiting re-assertion of the chip-select signal.

The communication interface may include Serial General-Purpose Input/Output (SGPIO), where driving to idle includes completing a current shift/update cycle and pausing further transactions by inhibiting issuance of a next LOAD (latch) strobe. The method may further include identifying, in response to the freeze signal, each communication interface that is actively mastered by sampling state indicators of a respective protocol-controller state machine in the programmable logic controller. Continuing operation under the updated firmware may include automatically resuming periodic polling or streaming schedules that were paused prior to freezing the I/O pin states. Staging the updated firmware may include background programming of the memory while the programmable logic controller continues to perform control functions in the powered system. Implementations of the described techniques may be realized in hardware, as methods or processes, or on computer-readable media.

In another aspect, a system includes a management controller; a memory storing updated firmware for a programmable logic controller while the system remains powered; and the programmable logic controller operatively coupled to the management controller, the memory, and a plurality of communication interfaces. The programmable logic controller includes control logic configured to receive, from the management controller, a freeze signal requesting I/O-state freeze for an impending firmware reload; in response to the freeze signal and prior to the I/O-state freeze, drive each communication interface that the programmable logic controller is actively mastering to an idle state by completing any in-progress transaction on the interface and pausing initiation of subsequent transactions; freeze I/O pin states for a bounded interval; during the bounded interval, receive a reload command from the management controller and, in response, switch execution from prior firmware to the updated firmware; and unfreeze the I/O pin states and continue operation under the updated firmware. Other embodiments of this aspect include corresponding computer systems, apparatus, and computer programs recorded on one or more computer-storage devices, each configured to perform the actions of the method.

Implementations of the system may include one or more of the following features. The programmable logic controller may include one or more writable configuration registers that store a guard-interval delay set by the management controller, and the control logic may defer freezing of the I/O pin states until expiration of the guard-interval delay to allow proactive driving of the plurality of communication interfaces to complete. At least one of the plurality of communication interfaces may include an Inter-Integrated Circuit (I²C) bus, and the control logic may be further configured to complete a current data byte and generate a STOP condition, and to pause further transactions by inhibiting assertion of a subsequent START condition. Implementations of the described techniques may be realized in hardware, as methods or processes, or on computer-readable media.

In a further aspect, a non-transitory computer-readable medium stores instructions that, when executed by control logic of a programmable logic controller in a powered system, cause the programmable logic controller to receive a freeze signal from a management controller requesting I/O-state freeze for an impending firmware reload; prior to the I/O-state freeze, drive each communication interface that the programmable logic controller is actively mastering to an idle state by completing any in-progress transaction on the interface and pausing initiation of subsequent transactions; freeze I/O pin states for a bounded interval; during the bounded interval, receive a reload command from the management controller and, in response, switch execution from prior firmware to updated firmware stored in a memory accessible to the programmable logic controller; and unfreeze the I/O pin states and continue operation under the updated firmware. Other embodiments of this aspect include corresponding computer systems, apparatus, and computer programs recorded on one or more computer-storage devices, each configured to perform the actions of the method.

Implementations of the non-transitory computer-readable medium may further cause the programmable logic controller, for an Inter-Integrated Circuit (I²C) communication interface, to complete a current data byte and generate a STOP condition, and to pause further transactions by inhibiting assertion of a subsequent START condition as part of driving the I²C communication interface to the idle state. Implementations of the described techniques may be realized in hardware, as methods or processes, or on computer-readable media.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates a system context diagram showing a baseboard management controller (BMC) performing remote firmware updates of on-board programmable logic devices, in accordance with some embodiments.

FIG. 2 illustrates an example workflow of a pin-state-freeze (“hitless”) firmware update that ignores protocol state on host-mastered interfaces.

FIG. 3 illustrates a workflow of a protocol-aware (“bus-safe release”) hitless firmware update that quiesces host-mastered interfaces before reload, according to some embodiments.

FIG. 4 illustrates an example diagram of a configurable guard-interval delay during the hitless firmware update with bus-safe release, in accordance with some embodiments.

FIG. 5 illustrates an example method of hitless firmware update with bus-safe release, according to one example embodiment.

FIG. 6 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

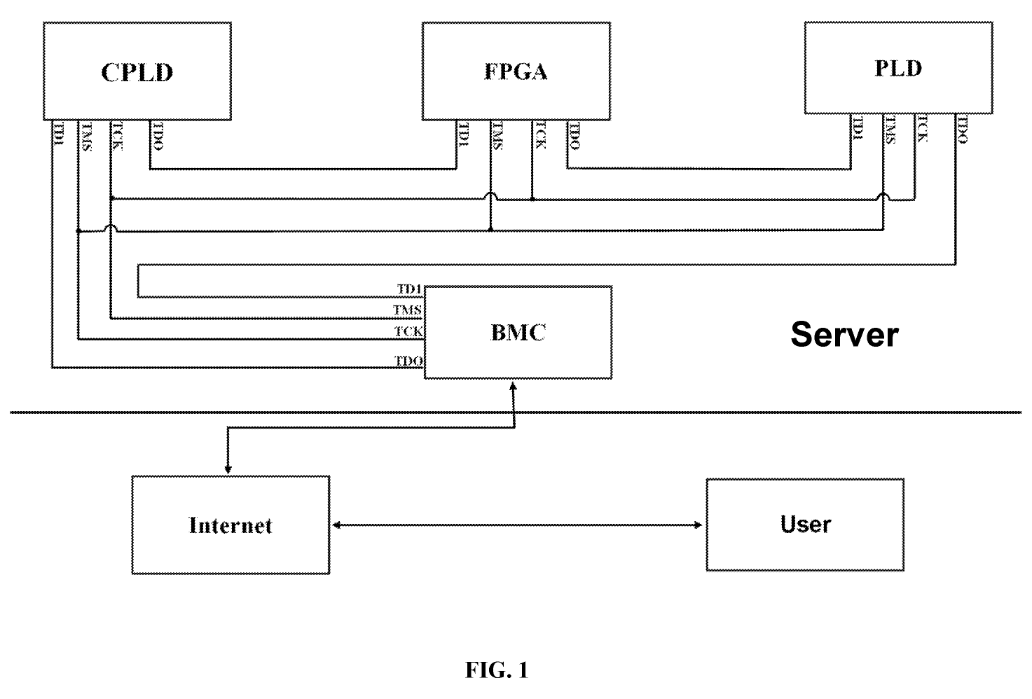

FIG. 1 illustrates a system context diagram showing a baseboard management controller (BMC) performing remote firmware updates of on-board programmable logic devices, in accordance with some embodiments. A server includes one or more programmable logic controllers/devices—such as a complex programmable logic device (CPLD), a field-programmable gate array (FPGA), or another programmable logic device (PLD)—coupled to the BMC and to configuration memory. The BMC communicates with a remote client over a data network (e.g., Ethernet via the Internet), receives a firmware image, stages the image in local memory, and programs a target device over a programming/control link such as a Joint Test Action Group (JTAG) scan chain using test clock (TCK), test mode select (TMS), test data in (TDI), and test data out (TDO) signals, or another management interface, while system power remains applied.

In representative deployments, the BMC exposes an embedded management service that accepts an uploaded, standardized programming file (e.g., a vector-based file encoding JTAG operations). The BMC decodes the uploaded data and applies the corresponding programming vectors to the on-board programming link—either via a native JTAG controller or by generating compliant waveforms through general-purpose input/output (GPIO). The target programmable logic device writes the image to configuration/storage elements and can be commanded by the BMC to reload the updated firmware. For robustness, the programming link may be arranged as a closed loop, enabling the BMC to compare device feedback on a return path with expected responses and, if needed, re-issue portions of the programming sequence.

Each programmable logic device shown in FIG. 1 can be independently addressed on the programming link and may serve a different role. A CPLD commonly hosts low-speed, protocol-based management interfaces (e.g., sensor polling and enclosure/backplane control), asserts power-enable signals, and coordinates board-level sequencing; an FPGA may implement higher-performance datapaths or glue logic; and other PLDs may drive indicators or backplane links. Reloading any of these devices resets internal state machines and, depending on configuration, can temporarily disable or tri-state input/output drivers until the new configuration becomes active.

Because modern servers are expected to remain powered and available, firmware maintenance is carried out remotely and in place, without removing alternating-current power or manual intervention. However, simply reloading a device while live can interrupt managed functions. In particular, when the CPLD is acting as the host of one or more protocol-based communication interfaces, a reload that does not account for protocol state can bisect an active transfer, leave an interface non-idle, trigger transient alarms or false faults, and obscure telemetry needed for thermal or power protection; recovery may require timeout-driven resets, explicit bus-clearing sequences, or resets of attached components.

Accordingly, FIG. 1 provides the architectural backdrop for the hitless servicing techniques described herein: the BMC obtains and stages an image from a remote client, coordinates programming over a standardized link, and orchestrates a controlled reload while power remains applied. Subsequent figures detail protocol-aware coordination between the BMC and the CPLD so that host-mastered interfaces are driven to defined idle states before the reload window, thereby preserving stable I/O behavior and continuous monitoring and control during firmware maintenance.

Although FIG. 1 depicts a remote client communicating with the baseboard management controller over the Internet, the communication path is merely illustrative. Any management controller capable of staging and initiating a firmware update may be used, and any suitable transport (wired or wireless; local or remote), can deliver the update request or image. The techniques disclosed herein concern the programmable logic device’s coordinated behavior in response to an impending reload, independent of the particular control channel or protocol used to convey the update.

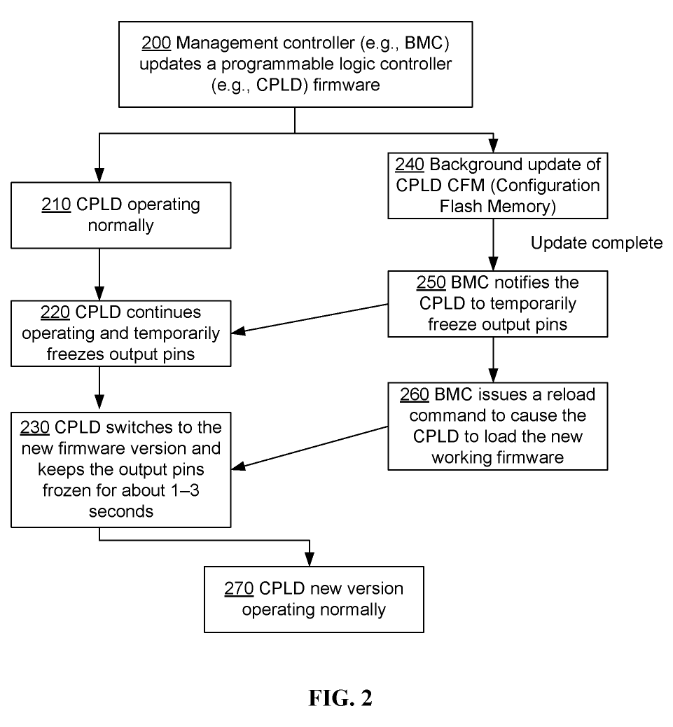

FIG. 2 illustrates an example workflow of a pin-state-freeze (“hitless”) firmware update flow in which the BMC initiates a CPLD (e.g., an example programmable logic device) firmware refresh (upgrade or downgrade, collectively called “update”) and the CPLD attempts to ride through the reload by freezing its output pin states. At 200, the BMC begins a CPLD firmware update while the server remains powered. In parallel with normal CPLD operation at 210, the BMC performs a background refresh of the configuration flash memory that stores the firmware image for the CPLD, shown at 240. This background programming is intended to be non-disruptive; the CPLD continues to execute its existing firmware and to drive its outputs while the configuration flash memory is rewritten.

When the background refresh completes, the BMC asserts a freeze signal to the CPLD, depicted at 250. The freeze signal requests an I/O-state freeze, during which the CPLD holds the present logic level on its output pins so that downstream loads (such as rail-enable pins, reset lines, board-straps, fan or LED drivers, and other board-level controls) do not see spurious edges or tri-state intervals during the impending reload. By electrically latching the outputs at the I/O pins, the CPLD masks the temporary loss of internal configuration that occurs while the new firmware image is brought online; power sequencing remains unchanged, indicator states remain steady, and watchdog/reset inputs to attached devices are not inadvertently toggled. In response, the CPLD enters the pin-hold state at 220, where it continues to run but maintains its output states for a bounded window. This electrical hold generally achieves “hitless” behavior for level-based control signals and loads that tolerate a brief pause in update activity; however, it does not interrogate or coordinate the protocol state of any host-mastered communication interface (i.e., the CPLD acting as a host for a communication channel).

While the I/O pins of the CPLD are frozen, the BMC issues a reload command at 260. The reload command causes the CPLD to switch from executing the prior firmware to executing the newly programmed firmware image. During the transition to the new firmware image, the CPLD maintains its I/O pins in the frozen state for a bounded time window, commonly on the order of one to three seconds, as shown at 230, to allow the internal configuration and initialization sequence to complete and to provide a margin for downstream circuitry to settle.

After the bounded freeze window expires, the CPLD releases the pin-hold and resumes normal operation under the new firmware, as indicated at 270. In this approach, the resumption is largely time-based; once the freeze interval ends, the CPLD’s new image takes over responsibility for bus controllers, GPIO, and other managed resources. The BMC typically treats the reload as complete at this point and returns the system to its steady-state management cadence.

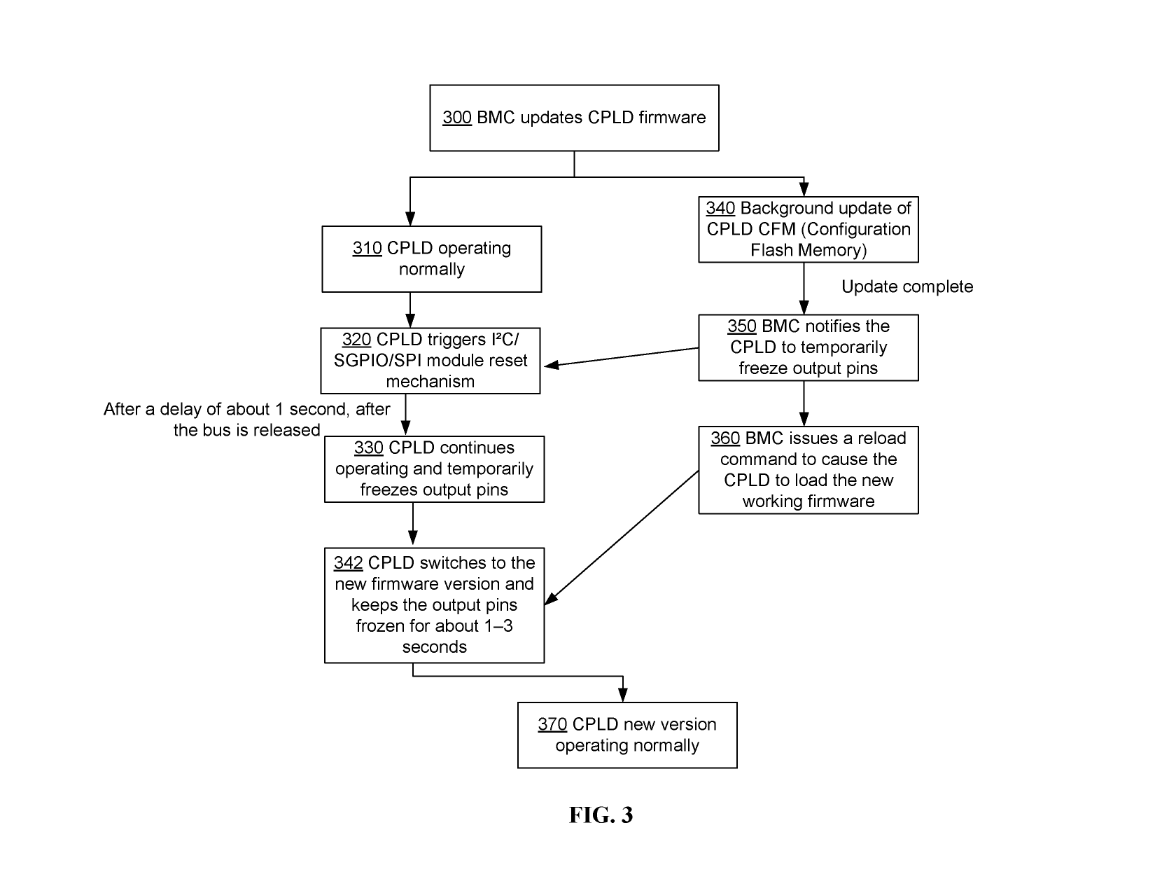

This conventional flow preserves output levels during the reload interval but operates only at the electrical pin level. It does not consider whether the CPLD, acting as a host on one or more protocol-based interfaces, was mid-transaction when the freeze request arrived. As a result, an active transfer can be bisected: a serial bus may be left without a protocol-defined end-of-transfer, a chip-select may remain asserted across the reload, or a shift stream may be truncated. These non-idle, partial-transfer conditions lead to stuck-bus states, transient faults, and recovery sequences driven by timeouts or explicit bus clearing after the reload—limitations addressed by the protocol-aware “bus-safe release” workflow described with respect to FIG. 3.

FIG. 3 illustrates a protocol-aware (“bus-safe release”) hitless update workflow that quiesces communication interfaces before a reload while system power remains applied.

At 300, a baseboard management controller (BMC) may initiate a CPLD firmware update. While the CPLD continues its normal control functions at 310, the BMC may program an updated image into a configuration flash memory (CFM) in the background, shown at 340, so that device services remain available.

When background staging at 340 completes, the BMC may notify the CPLD at 350 that an I/O-state freeze and reload are impending. In response, prior to freezing I/O, the CPLD may execute step 320 to quiesce any host-mastered communication interface. Here, “host-mastered communication interface” refers to any protocol link for which the CPLD acts as the bus master or frame originator (for example, an Inter-Integrated Circuit (I²C) controller that issues START/STOP conditions, a Serial Peripheral Interface (SPI) controller that asserts chip-select, or a Serial General-Purpose Input/Output (SGPIO) engine that clocks and latches shift data). Because the CPLD originates timing and control on such links, an abrupt reload may bisect an in-flight transfer and leave the counterpart device waiting in a non-idle state. The flow in FIG. 3 therefore adds a proactive, protocol-aware quiescence step before any electrical I/O pin freezing occurs.

In some embodiments, the CPLD samples state indicators of its protocol-controller state machines to identify which host-mastered communication interfaces are actively engaged, and for each such host-mastered communication interface completes the current transfer to the protocol’s end-of-transfer condition (e.g., STOP on I²C, frame end with chip-select de-assert on SPI, or completion of a shift/update cycle on SGPIO) while inhibiting initiation of any subsequent transfer. This quiescence may be performed concurrently across multiple host-mastered communication interfaces or serialized according to a local priority policy.

To ensure that end-of-transfer signaling is observed (e.g., generated by CPLD), the CPLD may defer entry into the electrical I/O-state freeze for a guard-interval delay. As depicted between steps 320 and 330 (“After a delay of about 1 second, after the bus is released”), the delay may be programmable by the BMC (e.g., via a writable register) and may be derived from bus clock rate, a minimum number of clock cycles required for the protocol-defined completion, and a safety margin. In some embodiments, the CPLD can directly confirm protocol completion through controller flags, then the guard-interval delay may be shortened or omitted.

After host-mastered communication interfaces have been quiesced and any guard-interval delay has expired, the CPLD may freeze its I/O pin states at 330 for a bounded interval while power remains applied. During this window, the BMC may issue a reload command at 360 that causes the CPLD to switch execution from the prior firmware image to the updated image already staged in the CFM. The I/O-state freeze maintains stable logic levels on outputs such as rail enables, resets, fan controls, and indicator lines so that downstream loads do not experience spurious edges or tri-state intervals during reconfiguration.

Following the reload command, the CPLD may switch to the new firmware and keep the I/O-state freeze asserted for a short, bounded period (e.g., about 1–3 seconds) to allow internal initialization and downstream settling; this is shown at 342. The bounded interval may be fixed by platform design or configured by the BMC based on measured reconfiguration time.

When reconfiguration completes, the CPLD may unfreeze the I/O pin states and resume operation under the updated firmware at 370. Because host-mastered interfaces were previously driven to protocol-defined idle states at 320, attached (remote or local) devices remain in well-defined conditions and stuck-bus or half-transfer states are avoided. The CPLD may automatically resume periodic polling or streaming schedules that were paused prior to the freeze, starting from the idle state on each interface; alternatively, the BMC may explicitly command resumption, or gate resumption on health checks of critical rails, sensors, or watchdog timers.

The workflow of FIG. 3 may be transport-agnostic with respect to how the firmware update request or firmware image reaches the BMC and with respect to the mechanism used to trigger reload. The BMC may communicate over Ethernet or another management network, and may employ a Joint Test Action Group (JTAG) link, a serial control channel, or other management interface to issue the reload at 360. Likewise, the CPLD referenced here may be a dedicated CPLD or an FPGA configured to provide board-management functions. In each case, the protocol-aware quiescence before the I/O-state freeze may reduce or eliminate post-reload recovery procedures and maintain continuous management visibility during the upgrade interval.

The workflow of FIG. 3 differs from the workflow of FIG. 2 in two material respects that, in some embodiments, minimize or even eliminate transient failures. First, FIG. 2 relies solely on an electrical I/O-state freeze before reload and does not consider protocol state on links mastered by the CPLD. As a result, an active transfer may be bisected and a counterpart device may remain in a non-idle condition until post-reload recovery completes. By contrast, FIG. 3 adds a protocol-aware quiescence step (320) executed before the I/O-state freeze (330). The CPLD identifies any host-mastered interface that is active, drives that interface to a protocol-defined end-of-transfer, and inhibits initiation of subsequent transfers so each interface reaches an idle state. Second, FIG. 3 optionally introduces a configurable guard-interval delay between quiescence and freezing, ensuring that end-of-transfer signaling is generated by the CPLD. Together, these additions maintain both electrical continuity and logical consistency across the reload window, which may prevent stuck-bus conditions, avoid false alarms and watchdog events, reduce or eliminate recovery procedures, and enable immediate, clean resumption of polling or streaming under the updated firmware.

As used herein, “drive” means that the a programmable logic controller’s (such as CPLD) host-side protocol logic (via code) actively causes (e.g., monitor, or actively listen to) and/or withholds signaling required by the applicable protocol to reach a defined state, including one or more of asserting or de-asserting control lines, issuing or withholding clock edges, emitting end-of-transfer primitives, advancing internal state machines, and gating new transactions; the exact signaling may vary by protocol (for example, generating an end-of- transfer primitive on a two-wire bus or de-asserting a frame select on a serial frame bus), but the result is a protocol-compliant idle state.

In some embodiments, the workflow of FIG. 3 is realized by a system that includes a management controller (e.g., a BMC), a memory that stores an updated firmware image for a CPLD while platform power remains applied, and the CPLD coupled to both the management controller and the memory as well as to multiple communication interfaces. The CPLD may include control logic configured to (i) receive a freeze signal from the management controller that requests an I/O-state freeze for an impending reload, (ii) prior to the I/O-state freeze, proactively drive each host-mastered interface to an idle state by completing any in-progress transaction and pausing initiation of subsequent transactions, (iii) freeze I/O pin states for a bounded interval, (iv) during that interval, receive a reload command from the management controller and, in response, switch execution from prior firmware to the updated firmware, and (v) unfreeze the I/O pin states and continue operation under the updated firmware.

The functional sequence of FIG. 3 can also be implemented as instructions stored on a non-transitory computer-readable medium (e.g., configuration flash associated with the CPLD or internal ROM/RAM). When executed by the CPLD’s control logic, such instructions may cause the CPLD to: receive the freeze signal, proactively drive each active interface to idle as described above, enter an I/O-state freeze for a bounded interval, receive a reload command and switch execution to the updated firmware staged in memory, and then unfreeze the I/O drivers and resume operation. For an I²C interface specifically, the instructions may direct the generation of a STOP condition upon completion of the current data byte and inhibit assertion of a subsequent START as part of the proactive drive to idle.

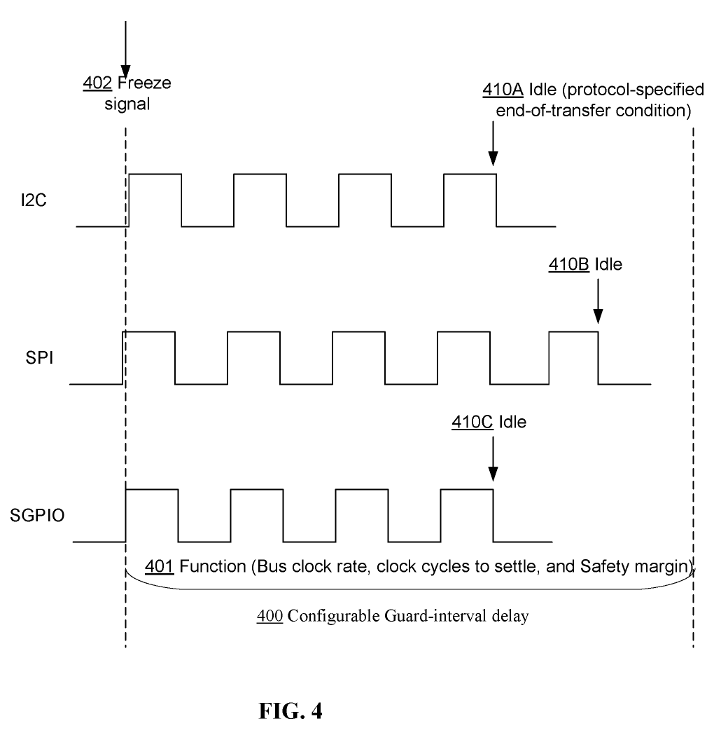

FIG. 4 illustrates, in some embodiments, a timing diagram for a configurable guard-interval delay 400 used during a protocol-aware, hitless update with bus-safe release. The diagram depicts three representative host-mastered interfaces (e.g., Inter-Integrated Circuit (I²C), Serial Peripheral Interface (SPI), and Serial General-Purpose Input/Output (SGPIO)) that may be active when a freeze signal 402 is received from a BMC. After receipt of the freeze signal 402, the CPLD may quiesce each interface by allowing any in-progress transfer to complete to the protocol-defined end-of-transfer condition and inhibiting initiation of a subsequent transfer. Because different interfaces and even different transactions on the same interface can require different completion times, the CPLD may defer entry into the electrical I/O-state freeze for a guard interval 400 long enough for all active interfaces to settle. In the example shown, the I²C interface reaches its STOP condition and becomes idle at 410A, the SPI interface completes a frame and de-asserts chip-select at 410B, and the SGPIO stream completes a shift/update cycle at 410C. The guard interval 400 is selected to span the slowest-to-settle interface in the current context.

In some embodiments, the duration of the guard-interval delay 400 may be computed as a function 401 of one or more factors, for example: the bus clock rate for each active interface; the minimum number of clock edges or bit times required for a protocol-specified end-of-transfer; and a configurable safety margin to accommodate device latency, clock-stretching, or signal propagation. The CPLD may determine these factors dynamically by sampling controller state flags that indicate “transfer in progress,” “byte complete,” “frame complete,” or “STOP generated,” and may choose the delay as the maximum of the per-interface estimates so that all interfaces are guaranteed to be idle before freezing I/O. In alternative embodiments, the BMC may program the delay through a writable register based on platform policy, or the CPLD may shorten the delay opportunistically if all interfaces report completion prior to expiration. By ensuring that multiple concurrently active protocols are each driven to their respective idle states before asserting the I/O-state freeze, the guard interval 400 helps maintain logical consistency across the reload window and minimizes the need for post-reload recovery.

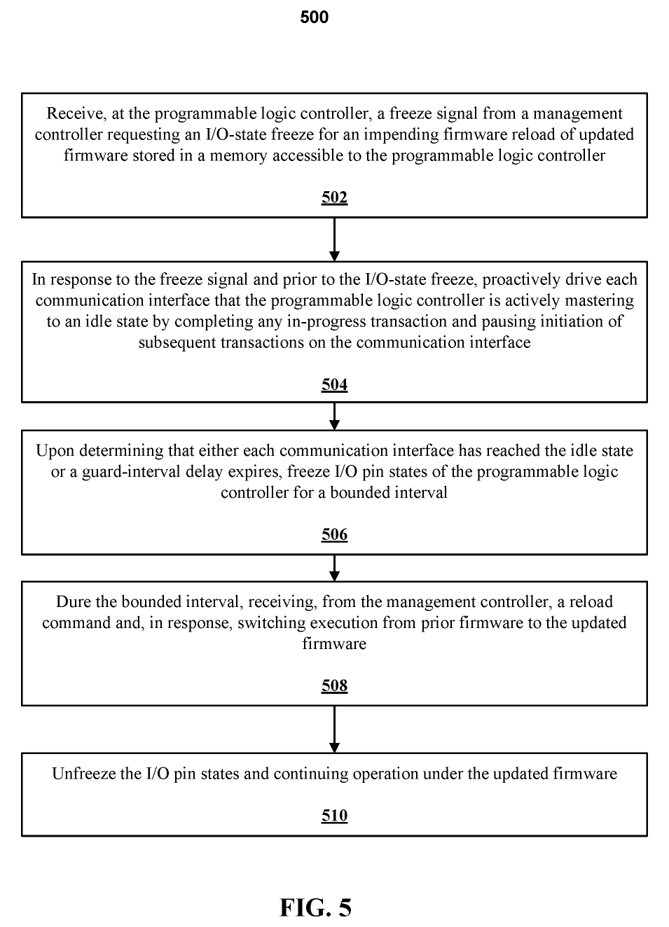

FIG. 5 is a flowchart of an example process 500. In some implementations, one or more blocks of FIG. 5 may be performed by a device.

As shown in FIG. 5, process 500 may begin by receiving, at the programmable logic controller, a freeze signal from a management controller requesting an I/O-state freeze for an impending firmware reload of updated firmware stored in a memory accessible to the programmable logic controller (block 502). For example, the device may receive the freeze signal as part of a coordinated update sequence, as described above.

In response to the freeze signal—and prior to the I/O-state freeze—the device may drive each communication interface that the programmable logic controller is actively mastering to an idle state by completing any in-progress transaction and pausing initiation of subsequent transactions on the interface (block 504). In some implementations, this quiescing occurs before any electrical pin hold is applied, thereby preventing mid-transfer truncation.

Process 500 may then include, upon determining that either each communication interface has reached the idle state or a guard-interval delay expires, freezing I/O pin states of the programmable logic controller for a bounded interval (block 506). For example, the device may latch output levels so downstream loads continue to see stable logic states while the reload proceeds.

During the bounded interval, the device may receive, from the management controller, a reload command and, in response, switch execution from prior firmware to the updated firmware (block 508). In some implementations, this handoff is completed while pins remain held to avoid observable glitches on controlled rails and indicators.

After the reload completes, the device may unfreeze the I/O pin states and continue operation under the updated firmware (block 510). In some implementations, normal scheduling on the communication interfaces may resume from the previously established idle states.

Process 500 may include additional implementations—individually or in combination with one another—or be used in connection with other processes described herein. In a first implementation, the continuing operation may include resuming, from the idle state, initiation of transactions on each communication interface whose initiation was paused.

In a second implementation, alone or with the first, completing the in-progress transaction may include refraining from freezing one or more I/O pin states associated with each communication interface until the programmable logic controller has generated a protocol-specified end-of-transfer condition on that interface.

In a third implementation, alone or with the first and second, driving each communication interface to the idle state may be performed concurrently across a plurality of communication interfaces.

In a fourth implementation, alone or with one or more of the first through third, process 500 may include, prior to freezing the I/O pin states, introducing a guard-interval delay sufficient for the proactive driving to complete, the guard-interval delay being configurable.

In a fifth implementation, alone or with one or more of the first through fourth, the guard-interval delay may be set by the management controller via a writable register of the programmable logic controller, and determined based at least on a bus clock rate, a minimum number of clock cycles to complete a protocol-specified end-of-transfer, and a configurable safety margin.

In a sixth implementation, alone or with one or more of the first through fifth, the bounded interval during which the I/O pin states are frozen may be configurable.

In a seventh implementation, alone or with one or more of the first through sixth, the management controller may include a baseboard management controller.

In an eighth implementation, alone or with one or more of the first through seventh, the memory may include a configuration flash memory storing a firmware image for the programmable logic controller.

In a ninth implementation, alone or with one or more of the first through eighth, the communication interface may include an I²C bus, and driving the interface to the idle state may include completing a current data byte and generating a STOP condition, and pausing further transactions by inhibiting assertion of a subsequent START condition.

In a tenth implementation, alone or with one or more of the first through ninth, the communication interface may include a Serial Peripheral Interface (SPI), and driving the interface to the idle state may include completing a current frame boundary and de-asserting a chip-select signal, and pausing further transactions by inhibiting re-assertion of the chip-select signal.

In an eleventh implementation, alone or with one or more of the first through tenth, the communication interface may include Serial General-Purpose Input/Output (SGPIO), and driving the interface to the idle state may include completing a current shift/update cycle and pausing further transactions by inhibiting issuance of a next LOAD (latch) strobe.

In a twelfth implementation, alone or with one or more of the first through eleventh, process 500 may further include identifying, in response to the freeze signal, each communication interface that is actively mastered by sampling state indicators of a respective protocol-controller state machine in the programmable logic controller.

In a thirteenth implementation, alone or with one or more of the first through twelfth, continuing operation under the updated firmware may include automatically resuming periodic polling or streaming schedules that were paused prior to freezing the I/O pin states.

In a fourteenth implementation, alone or with one or more of the first through thirteenth, staging the updated firmware may include background programming of the memory while the programmable logic controller continues to perform control functions in the powered system.

Although FIG. 5 shows example blocks of process 500, in some implementations process 500 may include additional blocks, fewer blocks, different blocks, or blocks arranged differently than those depicted in FIG. 5. Additionally or alternatively, two or more of the blocks of process 500 may be performed in parallel.

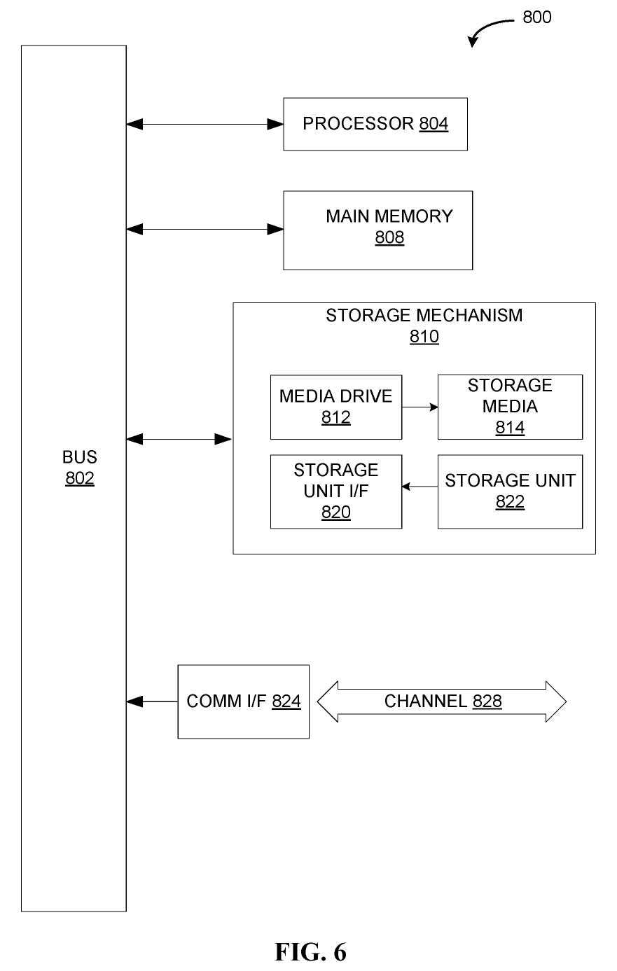

FIG. 6 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 800. After reading this description, it will become apparent to a person skilled in the relevant art how to implement the application using other computing modules or architectures.

Referring now to FIG. 6, computing module 800 may represent, for example, computing or processing capabilities found within desktop, laptop, notebook, tablet, cloud and edge, computers; hand-held computing devices (tablets, PDA’s, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor- implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain

embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for performing a hitless firmware update of a programmable logic controller in a powered system, comprising:
receiving, at the programmable logic controller, a freeze signal from a management controller requesting an Input/Output(I/O)-state freeze for an impending firmware reload of updated firmware stored in a memory accessible to the programmable logic controller; in response to the freeze signal and prior to the I/O-state freeze, driving each communication interface that the programmable logic controller is actively mastering to an idle state by completing any in-progress transaction and pausing initiation of subsequent transactions on the communication interface; upon determining that either each communication interface has reached the idle state or a guard-interval delay expires, freezing I/O pin states of the programmable logic controller for a bounded interval;
during the bounded interval, receiving, from the management controller, a reload command and, in response, switching execution from prior firmware to the updated firmware; and unfreezing the I/O pin states and continuing operation under the updated firmware.

2. The method of claim 1, wherein the continuing operation comprises:
resuming, from the idle state, initiation of transactions on each communication interface whose initiation was paused.

3. The method of claim 1, wherein completing the in-progress transaction comprises:
refraining from freezing one or more I/O pin states associated with each communication interface until the programmable logic controller has generated a protocol-specified end-of-transfer condition on the communication interface.

4. The method of claim 1, wherein driving each communication interface to the idle state is performed concurrently across a plurality of communication interfaces.

5. The method of claim 1, wherein the guard-interval delay being configurable.

6. The method of claim 1, wherein the bounded interval during which the I/O pin states are frozen is configurable.

7. The method of claim 1, wherein the management controller comprises a baseboard management controller.

8. The method of claim 1, wherein the memory comprises a configuration flash memory storing a firmware image for the programmable logic controller.

9. The method of claim 1, wherein the communication interface comprises an I²C bus, and driving the communication interface to the idle state comprises:
completing a current data byte and generating a STOP condition and pausing further transactions by inhibiting assertion of a subsequent START condition.

10. The method of claim 1, wherein the communication interface comprises a Serial Peripheral Interface (SPI), and driving the communication interface to the idle state comprises:
completing a current frame boundary and de-asserting a chip-select signal, and pausing further transactions by inhibiting re-assertion of the chip-select signal.

11. The method of claim 1, wherein the communication interface comprises Serial General-Purpose Input/Output (SGPIO), and driving the interface to the idle state comprises:
completing a current shift/update cycle, and pausing further transactions by inhibiting issuance of a next LOAD (latch) strobe.

12. The method of claim 1, further comprising:
identifying, in response to the freeze signal, each communication interface that is actively mastered by sampling state indicators of a respective protocol-controller state machine in the programmable logic controller.

13. The method of claim 1, wherein continuing operation under the updated firmware comprises:
automatically resuming periodic polling or streaming schedules that were paused prior to the freezing of the I/O pin states.

14. The method of claim 1, wherein staging the updated firmware comprises background programming of the memory while the programmable logic controller continues to perform control functions in the powered system.

15. The method of claim 1, wherein the guard-interval delay is set by the management controller via a writable register of the programmable logic controller, and
the guard-interval delay is determined based at least on:
a bus clock rate, and a minimum number of clock cycles to complete a protocol-specified end-of-transfer, and a configurable safety margin.

16. A system comprising:
a management controller; a memory storing updated firmware for a programmable logic controller while the system remains powered; and
the programmable logic controller operatively coupled to the management controller and the memory and to a plurality of communication interfaces, the programmable logic controller comprising control logic configured to:
receive, from the management controller, a freeze signal requesting I/O-state freeze for an impending firmware reload;
in response to the freeze signal and prior to the I/O-state freeze, drive each communication interface that the programmable logic controller is actively mastering to an idle state by completing any in-progress transaction on the communication interface and pausing initiation of subsequent transactions;
upon determining that either each communication interface has reached the idle state or a guard-interval delay expires, freeze I/O pin states of the programmable logic controller for a bounded interval; during the bounded interval, receive, from the management controller, a reload command and, in response, switch execution from prior firmware to the updated firmware; and unfreeze the I/O pin states and continue operation under the updated firmware.

17. The system of claim 16, wherein the programmable logic controller comprises:
one or more writable configuration registers that store the guard-interval delay set by the management controller.

18. The system of claim 16, wherein at least one of the plurality of communication interfaces comprises an Inter-Integrated Circuit (I²C) bus and
the control logic is further configured to complete a current data byte and generate a STOP condition, and to pause further transactions by inhibiting assertion of a subsequent START condition.

19. A non-transitory computer-readable medium storing instructions which, when executed by control logic of a programmable logic controller in a powered system, cause the programmable logic controller to:
receive a freeze signal from a management controller requesting I/O-state freeze for an impending firmware reload;
prior to the I/O-state freeze, drive a communication interface that the programmable logic controller is actively mastering to an idle state by completing any in-progress transaction on the communication interface and pausing initiation of subsequent transactions; upon determining that either the communication interface has reached the idle state or a guard-interval delay expires, freeze I/O pin states for a bounded interval; during the bounded interval, receive a reload command from the management controller and, in response, switch execution from prior firmware to updated firmware stored in a memory accessible to the programmable logic controller; and unfreeze the I/O pin states and continue operation under the updated firmware.

20. The non-transitory computer-readable medium of claim 19, wherein the instructions further cause the programmable logic controller, for an Inter-Integrated Circuit (I²C) communication interface, to:
complete a current data byte and generate a STOP condition; and
pause further transactions by inhibiting assertion of a subsequent START condition as part of driving the I²C communication interface to the idle state.
